(19) United States
(12) Patent Application Publication
(10) Pub. No.: US 2023/0153818 A1
(43) Pub. Date: May 18, 2023

(54) CIRCULAR POLARIZATION ANTENNA FOR USE IN DETECTING PRESENCE WITHIN A STRICTLY DEFINED WIRELESS ZONE

(71) Applicant: Simpello LLC, Monticello, IN (US)

(72) Inventors: William Benjamin Robertson, Monticello, IN (US); Jean-Samuel Chenard, Quebec (CA); Roger Mabillard, Quebec (CA)

(73) Assignee: Simpello LLC, Monticello, IN (US)

(21) Appl. No.: 18/156,816

(22) Filed: Jan. 19, 2023

Related U.S. Application Data
(63) Continuation of application No. PCT/US2021/042724, filed on Jul. 22, 2021.
(60) Provisional application No. 63/055,588, filed on Jul. 23, 2020.

(51) Int. Cl. G06Q 20/40; G01S 5/02; G01S 17/08; H01Q 9/04; G06Q 20/32; G06Q 30/0226; G06Q 20/20; G06Q 20/04

(52) U.S. Cl. CPC G06Q 20/40155; G01S 5/0295; G01S 17/08; H01Q 9/0428; G06Q 20/4014; G06Q 20/325; G06Q 20/3224; G06Q 30/0226; G06Q 20/20; G06Q 20/045; G06Q 20/3221

(57) ABSTRACT

A wireless proximity detection system employs short-range wireless communication implementing circular polarization to detect the proximity of a user device within a strictly defined wireless zone, regardless of its orientation and location on the user, and as a result trigger a desired action. The proximity detection system may utilize one or more patch antennas to define the wireless zone and the associated received signal strength(s) detected by the user's wireless device, as well as a distance-measuring device. A beacon may be utilized to prepare the user's mobile phone for detection as well as other antennas for coordination with the primary short-range antenna. The novel antenna structure allows a compact and low-cost fabrication method and the use of common printed circuit fabrication methods provide an integrated solution.

### CROSS REFERENCE TO RELATED APPLICATIONS

This application is a continuation of International Patent Application No. PCT/US2021/042724, filed Jul. 22, 2021 which claims the benefit of U.S. Provisional Application No. 63/055,588 filed Jul. 23, 2020 of which is hereby incorporated by reference.

### FIELD OF THE INVENTION

The present invention generally relates to a combination of radio transceiver and a specific antenna structure and antenna beam directivity manipulator which enables a system to accurately determine the position of a smartphone within a given radiation zone. This determination can enable an authenticated transaction to occur only when the user's smartphone is located within a specifically designated area.

### BACKGROUND

The invention described in this document provides a solution for fast, hands free transactions such as payments, reward programs, check-in solutions or similar quick transaction processing requiring personal identification. According to this invention, the personal identification and/or payment verification is exchanged wirelessly and in a seamless manner.

Smartphone utilization for payment and transactions has seen an important growth in acceptance and the use of near-field communication has traditionally been used to enable these types of transactions. However, near-field communication usually requires the smartphone, smartwatch or other token to be placed adjacent to the designated reader. Further improvement in the security, accuracy and user-convenience of these types of transactions is thus needed.

For small transactions, such as a coffee purchase or fast-food items, the use of the proximity of a smartphone to a vending machine or sales counter would ideally be able to authorize the transaction without needing the buyer to get their smartphone out of their pocket or add another layer of confirmation to the transaction, provided that the user is identified as being in close proximity of the vending machine or countertop during the transaction which is vetted by electronic means like a token exchange. In addition, due to the COVID-19 pandemic, the ability to minimize proximity and eliminate touch points and other forms of contact are strongly preferred and can greatly improve public health. The system disclosed herein (hereinafter “Personal Identification and Contactless Transaction System”) seeks to accomplish this type of transaction, albeit in a much more user-friendly, accurate and secure manner.

### BRIEF DESCRIPTION OF THE DRAWINGS

FIG. 1 is a front perspective view of one embodiment of a Personal Identification and Contactless Transaction System according to the present invention.

FIG. 2 is a diagrammatic view showing the antenna and RF elements of the Personal Identification and Contactless Transaction System of FIG. 1.

FIG. 3 is a diagrammatic view showing the internal components of the Personal Identification and Contactless Transaction System of FIG. 1.

FIG. 4 is a plan view of the Personal Identification and Contactless Transaction System of FIG. 1.

### DETAILED DESCRIPTION OF THE INVENTION

For the purposes of promoting and understanding of the principles of the invention, reference will now be made to the embodiment illustrated in the drawings and specific language will be used to describe the same. It will nevertheless be understood that no limitation of the scope of the invention is thereby intended. Any alterations and further modifications in the described embodiments, and any further applications of the principles of the invention as described herein are contemplated as would normally occur to one skilled in the art to which the invention relates.

Disclosed herein are unique antenna structure(s), and methods for using the same, which may be utilized in place of or in conjunction with the leaky feeder antennas and/or planar antennas disclosed in International App. No. PCT/US 19/22915 which was filed on Mar. 19, 2019. The antenna structure(s) and manipulations disclosed herein therefore may be utilized to achieve the same result achieved by the prior system albeit in a different form factor and with unique advantages. The contents of International App. No. PCT/US 19/22915 are hereby incorporated by reference to the extent not inconsistent.

Wireless technologies, especially short-range communication, have evolved rapidly in recent years. At this time, most of the cellular telephones integrate a Bluetooth low energy capable radio system that can interface with various peripherals including smartwatches, sensors and similar connected devices.

The use of Near Field Communication (NFC) technology has become a common means for payment or identification. Given its antenna coupling mechanisms and security paradigm, NFC technology suffers from having a very close proximity requirement (in the order of a few centimeters) which in most cases requires the user to intentionally manipulate a smartphone, card, watch or other enabled token very close to a terminal. The added security benefit of this short-range exchange is often a burden for the user, especially for very small transactions or for simple rapid identification where rigid security is not required. It would be advantageous if the user experience could be improved by removing the close proximity requirement of NFC while maintaining its security and accuracy in some or all situations.

The current invention described herein allows the use of Bluetooth Low Energy (BLE) technology, or another similar wireless standard, in a way that enables it to approximate the functionality of NFC technology without many of the drawbacks, including its requirement for very close proximity. The Personal Identification and Contactless Transaction System which enables this on the host side is embodied in a small device, which in the illustrated embodiment is about the size of a deck of playing cards.

At a broad level, the Personal Identification and Contactless Transaction System described herein attempts to permit the detection of a user's entrance into a strictly defined wireless zone using a wireless device and have one or more desirable actions automatically taken on the user's behalf as a result. For example, a user's credit card information may be passed from the user's smartphone to a retail terminal connected to or integrated within the Personal Identification and Contactless Transaction System thereby providing a seamless transaction to the user which does not require any overt action, such as placing their smartphone near very close to an NFC reader or the like. In addition to the transactional embodiments described herein, it will be appreciated that similar embodiments of the proximity detection system to be described may also encompass systems application in the lodging and/or retail space as well as for triggering / controlling other desired actions in other fields and that the system is not limited to the various exemplary applications described herein.

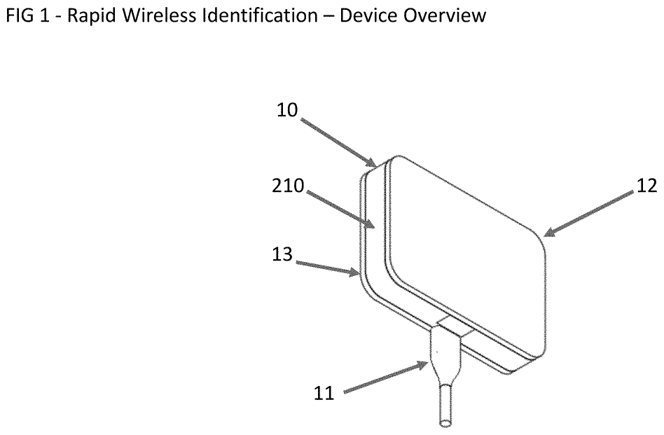

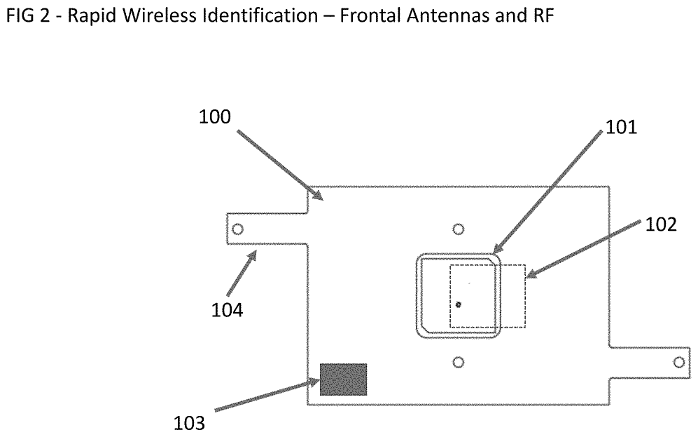

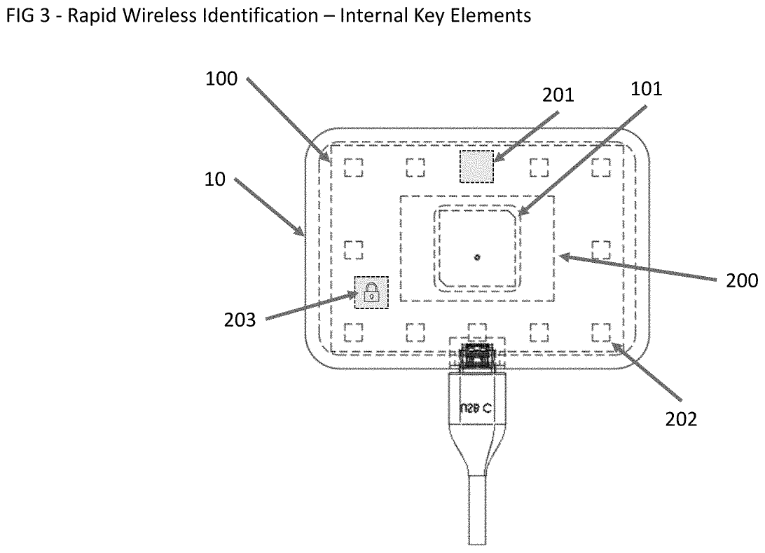

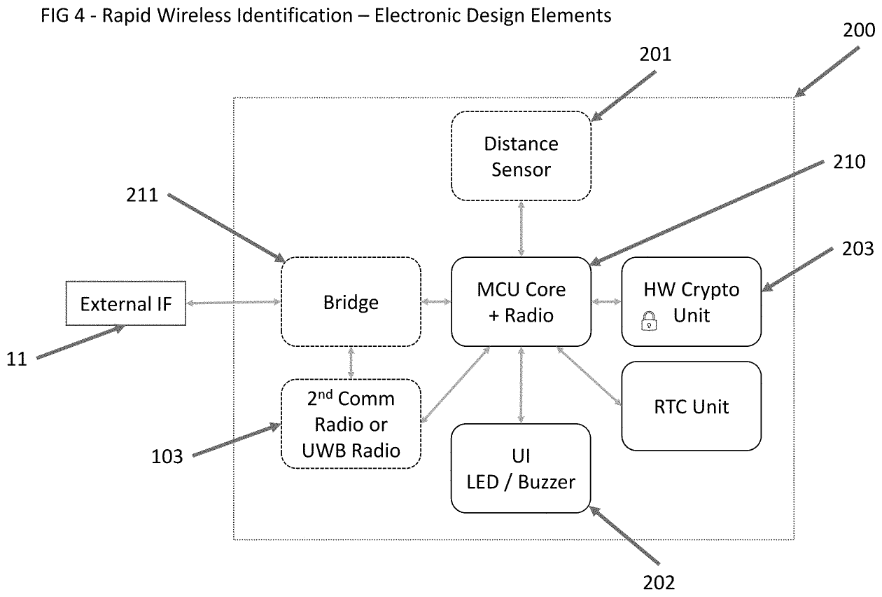

A Personal Identification and Contactless Transaction System according to one embodiment of the present invention is shown in FIGS. 1-4. The Personal Identification and Contactless Transaction System is provided in a compact housing that can be described as having a back-facing surface (13), a forward-facing surface (12) and a lateral ring providing thickness to the device (10). It shall be appreciated that the forward-facing surface (12) faces the user or the zone in which users along with their smartphones are expected to be and that the back-facing surface faces the opposite direction, and may be affixed to or against a surface, such as a wall of a terminal, kiosk, gate or the like. Within the thickness of the system, the integrated electronic system is comprised of a radio subsystem and peripherals (200), shown in detail in FIG. 3, and an antenna (100), shown in detail in FIG. 2. In optimized embodiments, both the electronic system and the antenna can be merged on the same physical card. Other embodiments are possible like a simpler plastic box enclosure, or a different size or shape thereof. The use of the above description helps with the explanation of the major components comprised in this disclosure.

One major problem when dealing with identifications of persons with Bluetooth solutions is the overall range and lack of precise RF zones within which the person can be identified. By using a combination of a weakened Bluetooth Low Energy signal, an antenna with special circular polarization and radiation pattern characteristics and with the optional addition of auxiliary correlating sensors, a rapid, hands-free and secure solution can be constructed and operated with high levels of user-convenience and accuracy.

The antenna construction can be described as a narrow band main identification zone antenna (101) operating in the ISM band (as defined by the ITU Radio Regulations (Article 5) in footnotes 5.138, 5.150, and 5.280 of the Radio Regulations). The use of other frequencies of operation are possible and contemplated, but for purposes of the illustrated embodiment, the same frequency bands centered at 2450 MHz are a good fit for use with Bluetooth. The Bluetooth Low Energy technology is ubiquitous in all modern cellular phones and personal portable devices and is thus a strong choice for use of this standard in this application.

In the illustrated embodiment, main identification zone antenna (101) is a patch antenna, and in a further form a ceramic patch antenna. It shall be appreciated that one or more antennas (101) may be utilized either independently or configured as one logical antenna. This main identification zone antenna (101) provides a front facing lobe of radiation energy which is projected towards the user approaching the identification device from within the strictly defined wireless zone. The signal fed to main identification zone antenna (101) is significantly attenuated (between −20 dB to −50 dB) and very well shielded prior to reaching the antenna by use on RF cages, buried transmission lines or similar techniques. The appropriate shielding zone (102) is illustrated, but other attenuation methods are possible such as a coaxial in-line attenuator with similar properties of avoiding any leakage of RF signal of interest around the unit.

The most cost-effective attenuation solution can be selected so long as it ensures that only a controlled amount of power exits the system in a directed and controlled manner. The main reason for the attenuator portion is that integrated radio transceivers generally do not allow very faint signals to be generated or do not provide very granular control on transmitted power as often times maximum range is desired. Most commercial chipset devices will support lowering the radio power via the firmware to something to the order of −20 dBm or sometimes a bit lower like −40 dBm. The added attenuation ensures that at the antenna feed port the signal is even weaker (i.e. −60, −70 or −80 dBm), ensuring a noticeably shorter range of communication which is important in the method. It further allows more control points as most commercial chipsets provide TX power adjustments in small increments around 0 dBm.

The use of ceramic patch antenna, or a set thereof, provides a compact structure along with the availability of circular polarization, both of which are beneficial. The use of patch antennas can provide very strict and directional patterns when integrated in this system. See International App. No. PCT/US 19/22915. Other antenna structures, technologies and designs may also be utilized to achieve a similar result.

Such short-range operation with attenuators in the signal path is limiting in some instances since a transaction cannot be initiated from a long distance. To alleviate this, and address issued associated therewith, a second distinct communication radio (103) can be added to support longer range communication or to send a beacon signal. The use of a beacon signal, capable of being received over a much greater range allows smartphone applications to be triggered upon reception of this beacon signal and thus ready themselves for communications with main identification zone antenna (101). The applications layers on the smartphone would take over the communication once the proximity signal generated by the main identification radio (210) is in range.

Furthermore, the secondary radio (103) can be used for zone reinforcement assistance by adding auxiliary sensors that are slaves the main identification zone antenna (101). The secondary communication radio acts as a wireless bridge to one or more auxiliary sensors that can confirm correlated signal acquisition within the strict zone. Methods to bridge sensors are abundant, the use of multi-role BLE communications (central and peripheral) using the longer-range radio can essentially take on this role. Network protocols abound and the secondary radio may combine multiple protocols and a common pattern is the combination of Wifi and Bluetooth LE. The Bluetooth LE can act as the application wakeup beacon and the Wifi radio as a networking interface allowing the sensor to communicate and exchange zone identification signals to the system in charge of making the decision to allow or reject the transaction.

The antenna structure may thus incorporate one or more auxiliary antennas (103) that can be of either narrowband ISM acting as the beacon secondary radio. Other embodiments may simply integrate a modular radio with integrated chip or printed circuit board antenna. If multiple radios are interfaced, they can coordinate the interactions via the main MCU core (210) or may use a communication bridge like a USB hub to push this coordination to the point-of-sale or control terminal. Since the antenna projects a front facing radiation lobe, the integration of the antenna may use non-conductive sections (104) as means to tilt the antenna within the enclosure to adjust the overall projected radiation beam pattern.

In another embodiment, the antenna structure is of ultra-wideband (UWB) type and can interact with phones equipped with such technology. The use of time-of-flight calculations using this antenna will help determine exactly the distance towards the sensor. The main antenna with a noticeably short range is used to ensure that the communication cannot be established from a long distance. It is also important to note that the presence of a dialect in the path of the UWB signal will affect distance calculations and thus can lead to false approaches. The reinforcement provided by the strict RF identification zone will reduce or eliminate those false possibilities.

A key feature of the main identification zone antenna (101) is being able to project a stronger frontal beam of radiation compared to the back side. This helps create a differentiation system between front and back. Other approaches in the same vein have been explored in creating a dual-antenna solution where each front-to-back ratio aim at reinforcing the location projection. See International App. No. PCT/US 19/22915. In this embodiment the back face 13 may incorporate RF absorbing material to further reduce the back lobe of the strict identification zone.

It was found that the main identification zone antenna (101) performs a lot better within the Personal Identification and Contactless Transaction System when it sends a signal of circular polarization. Such an antenna is typically used in GPS applications, but in this instance, the use of circular polarization is used to alleviate the effects which result from variations in the presentation and surroundings of the user's smartphone or other mobile device during interaction with the identification device. For example, the smartphone may be upside down in the user's pocket, laying face up in the user's purse or one of many other arrangements and surroundings, all of which affect RF transmission in unique ways. The circular polarization limits the variability introduced by cross-polarization attenuation between the user phone and the identification device. The antenna will have a lower link efficiency due to the fact that most cell phones and mobile devices tend to receive linearly polarized signals, but the benefit outweighs this result. Modern cell phones and mobile devices also make use of (multiple input, multiple output (MIMO) technology to increase data throughput, so having a circularly polarized RF signal emanating from the identification device will generally result in more predictable power measurement calculations.

One of the key parameters to begin the transaction process is the limited link budget and the presence of a stable link which is at the limits of the operable area within the range of interest in the proximity application which ranges between fifty (50) centimeters and one (1) meter, or between twenty-five (25) centimeters and one-half (0.5) meter. This represents the typical distance between a customer and the next customer behind them in a waiting queue, for example. If main identification zone antenna (101) used linear polarization the tilt/orientation of the phone or other mobile user device upon entering the operable zone or thereafter could easily result in a lower distance connection range. This would lead to either an inability to connect when desired or a subsequent loss of connection due to the cross-polarization effect with mobile phones and other user devices having a linear polarization bias. The use of a circularly polarized antenna alleviates the problem and makes the solution more stable and enables the desired operable wireless zone to be more strictly and reliably defined. The circularly polarized antenna also helps with the filtering algorithms that are required to estimate the cellular phone's position in the identification zone.

The construction of the unit benefits from a few elements that further improve the performance of the system. One of those elements is the shielding structure around all the RF elements of the system illustrated in zone 200 which may include all the identification radio circuitry. Any RF emanation from the PCB must be attenuated to ensure that only the specifically configured antenna participates in the creation of the radio link. At close distances, exposed microstrip traces, for example, may be sufficient to affect the overall pattern and even allow a connection. This would significantly impact the desired function of the antenna and thus the Personal Identification and Contactless Transaction System.

The unit construction can also make use of integrated distance sensors (201) that can provide either a simple distance to the first user or to some other object. This distance information, when correlated to signal strength variations, highly strengthens the identification process and enhances the state transition in the embedded system.

Some embodiments of the invention may use laser time-of-flight distance sensors, a simple linear reflector diode array. The use of a low-cost time-of-flight sensor is common in applications requiring a distance measurement between 10 mm and 2 m. This sensor, when integrated in the front face of the unit can correlate an approaching target with signal presence and increase. The signal remains weak in the zone but has a RF power that increases quite strongly as the phone gets close to the unit. The time-of-flight sensor information is then fused in the sensor using a filter. A common filter is Kalman, but other filters are possible if they can correlate RF signal from the target and correlate it with an approach or a near-sensor physical presence.

Upon departing, the distance sensor detects a large transition in distance (next person in the queue) and thus with diminishing signal and this state change can rapidly scan for a new user next in the waiting queue. This has the effect of increasing transactional efficiency of the system as the approach is done in 3 steps:
Large radius beacon signal—Wake up the application and prime the data exchange
Distance sensor pick-up of a target—Initiate filtered target identification
Short range radio pick-up—Initiate last stages of strict identification adding the RSSI signal information in the weak zone as the user enters the zone where the link and data exchange over the weak radio is present.

The user distance sensors need not be restricted to laser time-of-flight as they can also be of other technologies. As long as the distance to a potential target in front of the unit is possible along with its approximate range and speed, the algorithms can leverage and fuse this information with radio signal.

The use of a distance sensor with gesture detection can further enhance the system by allowing users to do simple air gestures as means of authenticating a transaction, for example. Other factors can be added to the system. For example, the use of retina signatures or facial recognition can be performed from auxiliary sensors. Provided that the extra authentication factors are obtained as the user stands within the RF identification zone, this approach will reinforce the mechanism. The key aspect of the invention is that the user is identified as a global target from the larger reach of the beacon mechanism and as they are approaching the short-range strict identification zone the local data exchange can be done. The use of an extra factor in the authentication like a PIN, air gesture, retina scan or face recognition is to ensure that the phone that is identified within the zone is accompanied by its user.

One key addition that is present in the invention is a hardware-based reinforce cryptographic engine (203). This ensures the creation of strong temporary tokens, the storage of authentication keys that confirm that the unit is genuine and using a cloud-based backend can strongly confirm the authenticity of a given transaction. This allows local authentication which may be used to speed up the identification process. The use of cloud platforms can perform the same identification but often with added latency.

The embodiment illustrated in FIGS. 1-4 is shown with a USB Type C interface, but it may use other serial interfaces like a CAN bus, Ethernet interface or the like. USB and USB Type C are more common on point of sales terminal. In addition, the USB allows the aggregation of multiple communication streams such that auxiliary radios can be handled such as the long-range transaction capabilities.

As mentioned above, some embodiments may include the use of Wifi for the communication between nodes and the attached system, such as a point-of-sale terminal or access control system, but the principle remains the same.

The use of a 2^{nd} radio brings numerous benefits. It generally takes a few packet exchanges to perform the authentication sequence. Having the ability to pre-exchange tokens and application information as users approach the identification device will accelerate the final transaction speed. In high-debit events such as sport venues where drinks, food, coffee have to be provided, the system can ensure that even with social distancing, privacy distancing, the users can be quickly passed through identification as the system will only require a few packets. The most compelling use case is to leverage the billions of Bluetooth Low Energy devices in the marketplace. Bluetooth Low Energy suffers from rather long interval between packets, so having the ability to prepare the transaction and only execute the last sequence near the terminal is a key element to enhance the customer experience and speed of transactions.

As previously mentioned, the secondary radio may also include other upcoming technologies like UWB. As such it can measure to some degree the approach distance to the user and order upcoming transactions by leveraging cache from the cloud services in addition to fast, low latency communication with the sensor. Currently, the integration of UWB technology did not reach critical mass adoption and thus are only present in a few high-end smartphones.

The embodiment may also include UX features such as colored LED arrays or rings (202), allowing the system to highlight its users detection, identification and also can be used in conjunction with gestures to allow quick and non-repeatable patterns as personal identification confirmation. For example, always swipe to the left when green and to the right when blue would be known by the end user, but not to bystanders and thus can be used to encode an 2nd factor sequence without the need to touch the terminal to enter a PIN for example. Such terminals may be contaminated with a virus, dirty or simply inconvenient to use.

While the invention has been illustrated and described in detail in the drawings and foregoing description, the same is to be considered as illustrative and not restrictive in character, it being understood that only the preferred embodiment has been shown and described and that all equivalents, changes, and modifications that come within the spirit of the inventions as described herein and/or by the following claims are desired to be protected.

Hence, the proper scope of the present invention should be determined only by the broadest interpretation of the appended claims so as to encompass all such modifications as well as all relationships equivalent to those illustrated in the drawings and described in the specification.

What is claimed is:

1. A presence detection system for detecting the presence of a wireless user device within a strict wireless zone and subsequently triggering a desired action, the system comprising:
a database storing identifying information for at least one wireless user device in association with instructions for initiating a desired action upon detecting that the wireless user device enters the strict wireless zone;
a set of one or more patch antennas connected to a low-power transmission source emitting circularly polarized electromagnetic waves, wherein the radiation patterns of the set of patch antennas defines the strict wireless zone;
a processor for determining whether the wireless user device is within the strict wireless zone based upon the strength of at least one of the signals received by the wireless device from the set of one or more patch antennas or received by the set of one or more patch antennas from the wireless device; and
a control unit for triggering the desired action based upon a determination by the processor that the wireless user device is within the strict wireless zone.

2. The presence detection system of claim 1, further comprising a distance sensor located adjacent to the set of one or more patch antennas and directed toward the strict wireless zone.

3. The presence detection system of claim 2, wherein the distance sensor is a laser time of flight sensor.

4. The presence detection system of claim 1, further comprising a beacon antenna, distinct from the set of one or more patch antennas, having a greater range than the set of one or more patch antennas.

5. The presence detection system of any of claim 4, wherein the set of one or more patch antennas emits primarily circularly polarized electromagnetic waves.

6. The presence detection system of claim 5, wherein the set of one or more patch antennas emits only circularly polarized electromagnetic waves.

7. The presence detection system of claim 1, wherein at least one of the patch antennas within the set of one or more patch antennas is a ceramic patch antenna.

8. The presence detection system of any of claim 1, wherein the desired action includes having the control unit populate a customer loyalty account associated with the wireless user device within a point of sale system.

9. The presence detection system of any of claim 1, further comprising electromagnetic shielding along the entire path from the low power transmission source to the set of one or more patch antennas.

10. The presence detection system of any of claim 1, further comprising electromagnetic shielding on all connections carrying electromagnetic radiation from the low power transmission source.

11. The presence detection system of any of claim 1, further comprising electromagnetic shielding cages to prevent electromagnetic radiation from exiting the presence detection system in a direction away from the strict wireless zone.

12. The presence detection system of claim 11, wherein the desired action includes redeeming a ticket for entry associated with the wireless user device for an event.

13. The presence detection system of claim 11, wherein the desired action includes permitting the user associated with the wireless user device to enter a restricted access area located adjacent to the strict wireless zone.

14. The presence detection system of claim 11, wherein the desired action includes completing the payment for a transaction using a payment method associated with the wireless user device using a point of sale terminal located adjacent to or within the strict wireless zone.

15. The presence detection system of claim 11, further comprising a signal attenuator which outputs a signal to the set of one or more patch antennas having a signal strength weaker than −40 dBm.

16. The presence detection system of claim 15, further comprising a signal attenuator which outputs a signal to the set of one or more patch antennas having a signal strength weaker than −60 dBm.

17. The presence detection system of claim 11, wherein the low-power transmission source is a Bluetooth radio.

18. The presence detection system of claim 11, wherein the low-power transmission source is an 802.11 radio.

19. The presence detection system of claim 11, wherein the set of one or more patch antennas operate within the ISM band.

20. An method for detecting the presence of a wireless user device within a strict wireless zone and subsequently triggering a desired action, the method comprising the steps of:
maintaining a database storing identifying information for at least one wireless user device in association with instructions for initiating a desired action upon detecting that the wireless user device enters the strict wireless zone;
establishing the strict wireless zone using a set of one or more patch antennas connected to a low power transmission source emitting circularly polarized electromagnetic waves, wherein the radiation patterns of the set of patch antennas defines the strict wireless zone;
determining with a processor whether the wireless user device is within the strict wireless zone based upon the strength of a signal received by the wireless device from the set of one or more patch antennas or received by the set of one or more patch antennas from the wireless device; and
triggering the desired action based upon a determination by the processor that the wireless user device is within the strict wireless zone.
